(19) United States
(12) Patent Application Publication
(10) Pub. No.: US 2023/0038463 A1
(43) Pub. Date: Feb. 9, 2023

(54) DETECTION DEVICE, DETECTION METHOD, AND DETECTION PROGRAM

(71) Applicant: NIPPON TELEGRAPH AND TELEPHONE CORPORATION, Tokyo (JP)

(72) Inventors: Tomokatsu TAKAHASHI, Musashino-shi, Tokyo (JP); Masanori YAMADA, Musashino-shi, Tokyo (JP); Yuki YAMANAKA, Musashino-shi, Tokyo (JP)

(73) Assignee: NIPPON TELEGRAPH AND TELEPHONE CORPORATION, Tokyo (JP)

(21) Appl. No.: 17/794,984

(22) PCT Filed: Feb. 12, 2020
(86) PCT No.: PCT/JP2020/005373

§ 371 Date: Jul. 25, 2022

(51) Int. Cl. G06N 3/08

(52) U.S. Cl. CPC G06N 3/08

(57) ABSTRACT

A detection device includes acquisition circuitry, conversion circuitry, and detection circuitry. The acquisition circuitry acquires data to be classified using a model. The conversion circuitry converts the data acquired using noise in a predetermined direction. The detection circuitry detects an adversarial example using a change in output between the data acquired and the data converted, at a time when the data acquired and the data converted are input to the model.

### TECHNICAL FIELD

The present invention relates to a detection device, a detection method, and a detection program.

### BACKGROUND ART

An adversarial example is known. The adversarial example is a sample created by artificially adding a minute noise to data, which is to be input to a deep learning model, so as to disturb an output. For example, an adversarial example of an image causes a problem in that an output of deep learning is erroneously classified without change in appearance of the image. In view of this, adversarial detection that detects an adversarial example is studied (refer to NPL 1 and NPL 2).

In adversarial detection, for example, a random noise is further added to an adversarial example and a change in output of deep learning is measured to detect the adversarial example. For example, an attacker adds, to normal data, such a noise as to slightly exceed a decision boundary between classes for data classification, and obtains data converted as an adversarial example. When a random noise is added to such an adversarial example and data is converted in a random direction, an output of deep learning changes in some cases. Thus, adversarial detection that uses a random noise can detect an adversarial example.

### CITATION LIST

### Non Patent Literature

[NPL 1] Ian J.Goodfellow et al., “Explaining and Harnessing adversarial examples”, arXiv:1412.6572v3 [stat.ML], [online], March 2015, [retrieved on Jan. 20, 2020], the Internet, <URL:https://arxiv.org/abs/1412.6572>
[NPL 2] Kevin Roth et al., “The Odds are Odd: A Statistical Test for Detecting adversarial examples”, arXiv:1902.04818v2 [cs.LG], [online], May 2019, [retrieved on Jan. 20, 2020], the Internet, the Internet, <URL:https://arxiv.org/abs/1902.04818>

### SUMMARY OF THE INVENTION

### Technical Problem

However, according to the related art, it is difficult to detect an adversarial example by using a random noise in some cases. For example, it is difficult to detect an adversarial example that is less likely to cause such a change in output of deep learning as to exceed a decision boundary through addition of a random noise.

The present invention has been made in view of the above, and an object of the present invention is to detect an adversarial example that cannot be detected by using a random noise.

### Means for Solving the Problem

In order to solve the above-mentioned problem and achieve the object, a detection device according to the present invention includes: an acquisition unit configured to acquire data to be classified by using a model; a conversion unit configured to convert the data acquired by using a noise in a predetermined direction; and a detection unit configured to detect an adversarial example by using a change in output between the data acquired and the data converted, at a time when the data acquired and the data converted are input to the model.

### Effects of the Invention

According to the present invention, it is possible to detect an adversarial example that cannot be detected by using a random noise.

### BRIEF DESCRIPTION OF DRAWINGS

FIG. 1 is a diagram for describing an example of an outline of a detection device according to this embodiment.

FIG. 2 is a schematic diagram for describing an example of an overall configuration of the detection device according to this embodiment.

FIG. 3 is a diagram for describing processing to be executed by a conversion unit.

FIG. 4 is a flow chart illustrating a detection processing procedure.

FIG. 5 is a diagram for describing an example.

FIG. 6 is a diagram for describing an example.

FIG. 7 is a diagram illustrating an example of a computer that executes a detection program.

### DESCRIPTION OF EMBODIMENTS

Now, description is given in detail of an embodiment of the present invention with reference to the drawings. This embodiment does not limit the scope of the present invention. In the description of the drawings, the same components are assigned with the same reference numerals.

[Outline of Detection Device]

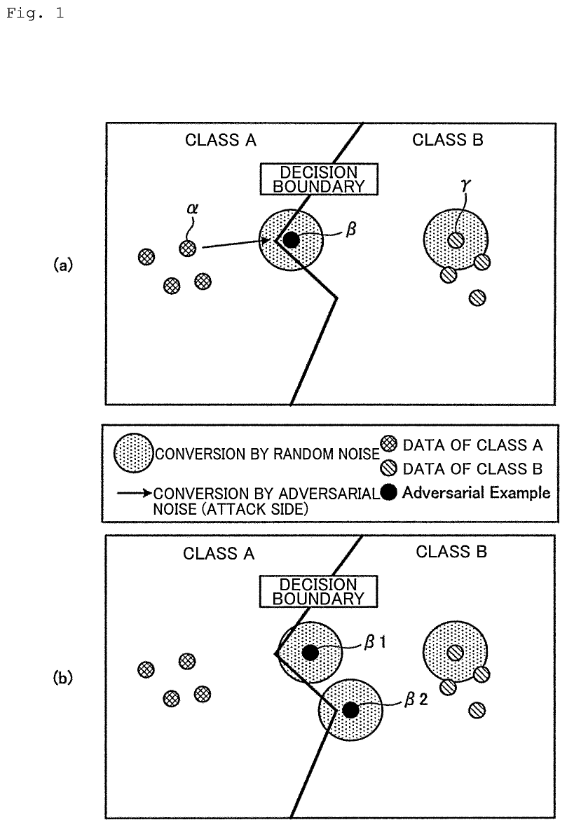

FIG. 1 is a diagram for describing an outline of a detection device according to this embodiment. An adversarial example is obtained by an attacker converting a clean sample, which is normal data, by using an adversarial noise, which is a minute noise. The adversarial noise is a minute noise that cannot be recognized by a person. The attacker adds, to a clean sample, such an adversarial noise as to exceed a decision boundary between classes for data classification in order to disturb an output, and obtains data converted as an adversarial example, which is an adversarial input sample. The attacker tries to create an adversarial example with the minimum conversion distance so that the adversarial example cannot be recognized by a person. Due to this reason, the adversarial example is often created near the decision boundary.

In the example illustrated in FIG. 1(a), a clean sample α classified by an adversarial noise into a class A is converted into an adversarial example β classified into a class B. When the adversarial example β is converted in a random direction through addition of a random noise, the adversarial example β may be classified into the class A or the class B. In contrast, normal data γ, which is a clean sample, is away from the decision boundary to some extent, and thus is classified into the class B without change even when the normal data γ is converted in a random direction with a random. noise. Adversarial detection detects an adversarial example by measuring a behavior of such change in class.

Meanwhile, even when an adversarial example is converted with a random noise, the class to be classified is less likely to change in some cases. For example, when an adversarial example exists in a region of the class B having a decision boundary with the class A protruding toward the class A as in the case of the adversarial example β illustrated in FIG. 1(a), the class to be classified changes from the class B to the class A in many cases. In contrast, when an adversarial example exists in an inner region of the class B away from the decision boundary as in the case of the adversarial example β1 illustrated in FIG. 1(b), the class to be classified remains the class B in many cases even when the adversarial example is converted with a random noise. Furthermore, when an adversarial example exists in a region of the class B having a decision boundary with the class A protruding toward the class B as in the case of the adversarial example β2, the class to be classified remains the class B in many cases even when the adversarial example is converted with a random noise.

When an attacker who does not know the decision boundary accurately has created an adversarial example at the position of the adversarial example (β1, β2) illustrated in FIG. 1(b) by coincidence, the related art cannot detect this adversarial example. Furthermore, when an attacker has intentionally increased the conversion distance and created an adversarial example to cope with adversarial detection that adds a random noise, the related art cannot detect this adversarial example.

In view of this, the detection device according to this embodiment adds an adversarial noise that can intentionally change the direction of conversion with respect to the decision boundary between classes instead of a random noise as described later, and converts data. With this method, the detection device detects the adversarial example (β1, β2) as illustrated in FIG. 1(b).

[Configuration of Detection Device]

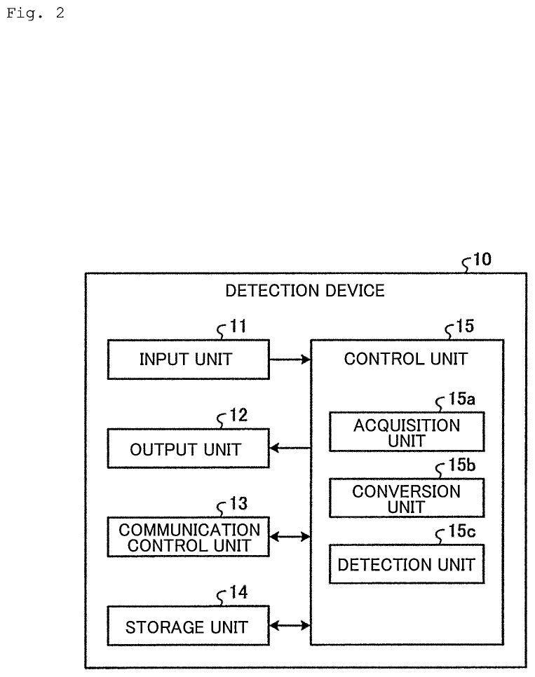

FIG. 2 is a schematic diagram for describing an example of an overall configuration of the detection device according to this embodiment. As exemplified in FIG. 2, the detection device 10 according to this embodiment is implemented by a general computer such as a personal computer, and includes an input unit 11, an output unit 12, a communication control unit 13, a storage unit 14, and a control unit 15.

The input unit 11 is implemented by using an input device such as a keyboard or a mouse, and the input unit 11 inputs various kinds of command information, such as start of processing, to the control unit 15 in response to an input operation performed by an operator. The output unit 12 is implemented by, for example, a display device such as a liquid crystal display or a printing device such as a printer. For example, the result of detection processing described later is displayed on the output unit 12, for example.

The communication control unit 13 is implemented by, for example, a NIC (Network Interface Card), and controls communication between the control unit 15 and an external device via a telecommunication line such as a LAN (Local Area Network) or the Internet. For example, the communication control unit 13 controls communication between the control unit 15 and a management device or the like that manages data to be subjected to detection processing.

The storage unit 14 is implemented by a semiconductor memory device such as a RAM (Random Access Memory) or a flash memory, or a storage device such as a hard disk or an optical disc. The storage unit 14 stores in advance, for example, a processing program that operates the detection device 10 and data to be used during execution of the processing program, or the storage unit 14 stores the processing program and the data temporarily every time the processing is executed. The storage unit 14 may be configured to communicate with the control unit 15 via the communication control unit 13.

The control unit 15 is implemented by using a CPU (Central Processing Unit) or the like, and executes the processing program stored in the memory. In this manner, as exemplified in FIG. 2, the control unit 15 functions as an acquisition unit 15a, a conversion unit 15b, a detection unit 15c, and a learning unit 15d. These functional units may each be implemented by hardware, or a part of these functional units may be implemented by different pieces of hardware. Furthermore, the control unit 15 may include other functional units.

The acquisition unit 15a acquires data to be classified by using a deep learning model. Specifically, the acquisition unit 15a acquires data to be subjected to detection processing described later from the management device or the like via the input unit 11 or the communication control unit 13. The acquisition unit 15a may store the data acquired into the storage unit 14. In that case, the conversion unit 15b described later acquires data from the storage unit 14 and executes processing.

The conversion unit 15b converts the data acquired by using a noise in a predetermined direction. For example, the conversion unit 15b converts the data by using, as the noise in a predetermined direction, a noise in a direction that approaches the decision boundary between classes to be classified by the deep learning model. Specifically, the conversion unit 15b adds an adversarial noise defined by the following expression (1) to the data acquired to convert the data.

$$\begin{matrix}[ Math . 1 ] & \\ Adversarial noise = - ε \times \frac{\partial L ( x , Target\_class )}{\partial x} & ( 1 )\end{matrix}$$

In expression (1), x represents input data, and target_class represents a class that is adjacent with respect to the decision boundary and is determined to be erroneously classified. Furthermore, L represents an error function that is used at the time of learning a deep learning model for classifying x, which is a function that returns a smaller value as the function is optimized more to output an ideal value. L(x, target_class) returns, for input data x, a smaller value as the predicted class output by the deep learning model becomes closer to target_class, that is, as x becomes closer to the decision boundary with target_class. Furthermore, ε represents a hyper parameter for setting the strength of a noise.

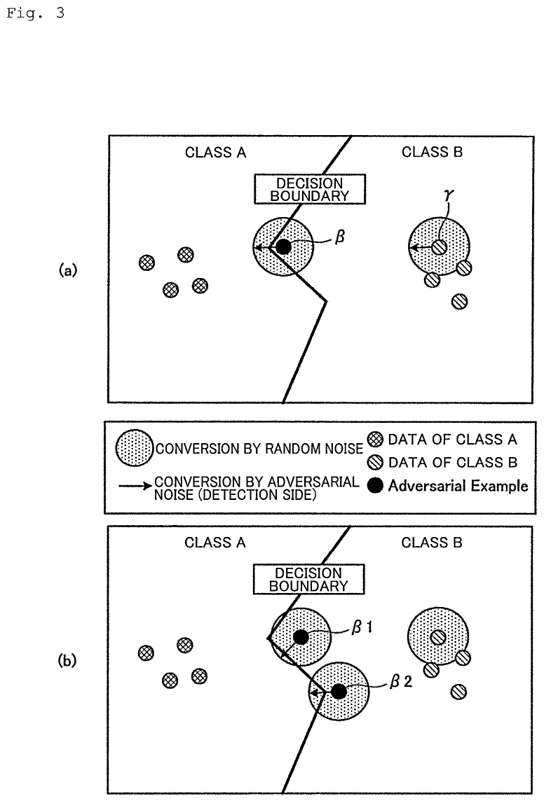

FIG. 3 is a diagram for describing processing to be executed by the conversion unit 15b. The conversion unit 15b converts data by using the adversarial noise represented by the above expression (1). As a result, as illustrated in FIG. 3(a), the adversarial example β existing in the region of the class B protruding toward the class A near the decision boundary with the class A is classified into the original class A. In contrast, the data γ, which is a clean sample away from the decision boundary to some extent, is classified into the class B, and does not cause a change in class.

In this manner, when a change in class classified by the deep learning model has occurred, the detection unit 15c can determine that the data is an adversarial example. As a result, in the detection device 10, the detection unit 15c described later can detect an adversarial example more efficiently than related-art adversarial detection that uses a random noise illustrated in FIG. 1(a).

The detection device 10 has learned in advance the deep learning model so as not to change an output when normal data (clean sample) is converted by using an adversarial noise on the detection side. As a result, the normal data γ of FIG. 3(a) is classified into the class B, and does not cause a change in class. Thus, the detection unit 15c can accurately determine that the normal data γ is not an adversarial example.

Furthermore, as illustrated in FIG. 3(b), the detection device 10 classifies the adversarial example β1 existing in the inner region of the class B away from the decision boundary into the original class A. Therefore, similarly to the adversarial example β of FIG. 3(a) described above, the detection unit 15c can determine that the adversarial example β1 is an adversarial example.

In other cases, when the adversarial example β1 is converted and placed near the decision boundary, the detection device 10 further converts the adversarial example β1 in the direction of the decision boundary, so that the adversarial example β1 is classified into the original class A. As a result, the detection unit 15c can detect that the adversarial example β1 is an adversarial example. Alternatively, similarly to the adversarial example β of FIG. 3(a) described above, related-art adversarial detection that uses a random noise additionally can also detect that the adversarial example β1 is an adversarial example.

Furthermore, the detection device 10 classifies the adversarial example β2, which exists in the region of the class B having a decision boundary with the class A protruding toward the class B, into the original class A. As a result, the detection unit 15c can detect that the adversarial example β2 is an adversarial example. In this manner, it is possible to detect an adversarial example that related-art adversarial detection using the random noise illustrated in FIG. 1(b) has a difficulty in detecting.

The conversion unit 15b may repeat the processing of calculating a noise and converting data by using the calculated noise a plurality of number of times. For example, the conversion unit 15b may repeat the processing of calculating, for data to which a noise smaller than ε shown in the above expression (1) is added, a noise by the above expression (1) again and adding the noise to the data. As a result, the conversion unit 15b can execute data conversion of adding a noise in the direction of the decision boundary more accurately.

Referring back to the description of FIG. 2, the detection unit 15c detects an adversarial example by using a change in output between the data acquired and the data converted at a time when the data acquired and the data converted are input to the deep learning model.

For example, the detection unit 15c calculates a predetermined feature AS (Anomaly Score) of data, which changes in response to a change in output of the deep learning model, and uses a change in output of this feature AS between the data acquired and the data converted to detect an adversarial example. When the feature AS has changed, that is, when a change in output of the deep learning model has occurred, the detection unit 15c determines that input data before addition of the adversarial noise calculated by the above expression (1) is an adversarial example.

Specifically, the detection unit 15c calculates the following expressions (2) and (3). y represents a predicted class output by the deep learning model for the input data x. Furthermore, x* represents a clean sample, that is, normal data that is not an adversarial example, y* represents a true class of x*, and z represents a class other than y.

[Math. 2]

f_{y}(x)=<w_{y}, ϕ(x)> (2)

where wᵢ represents the weight of a unit i (i-th unit) of the last layer of F, and φ(x) represents input to the last layer of F at a time when x is input

fᵢ(x)<wᵢ, ϕ(x)>

[Math. 3]

f_{y,z}(x)=f_{z}(x)−f_{y}(x)=<w_{z}−w_{y}, ϕ(x)> (3)

Furthermore, the detection unit 15c uses an adversarial noise ∇ calculated by the conversion unit 15b to calculate the following expression (4). E represents an expected value.

$$\begin{matrix}[ Math . 4 ] & \\ {g}_{y , z} ( x , ∇ ) := {E}_{t} [ {f}_{y , z} ( x + {∇}_{t} ) - {f}_{y , z} ( x ) ] where {∇}_{t} = - ε \times \frac{\partial L ( x , t )}{\partial x} & ( 4 )\end{matrix}$$

Furthermore, the detection unit 15c calculates, for a clean sample, an average indicated by the following expression (5) and a variance indicated by the following expression (6) with respect to a change in output through addition of an adversarial noise.

### [Math. 5]

μ_{y*,z}L=E_{x*|y*} E_{∇}_{ₜ}[g_{y*,z}(x*, ∇)] (5)

[Math. 6]

σ_{y*,z}²:=E_{x*|y*}E_{∇}_{ₜ}[∇ₜg_{y*,z}(x*, ∇)−μ_{y*,z}] (6)

Then, the detection unit 15c uses the above expressions (5) and (6) to calculate the following expression (7), and next calculates the feature AS indicated by the following expression (8).

$$\begin{matrix}[ Math . 7 ] & \\ {\overline{g}}_{y , z} ( x , ∇ ) := [ {g}_{y , z} ( x , ∇ ) - {μ}_{{y}^{*} , z} ] / {σ}_{{y}^{*} , z} & ( 7 )\end{matrix}$$

$$\begin{matrix}[ Math . 8 ] & \\ AS = {max}_{z} {\overline{g}}_{y , z} ( x , ∇ ) & ( 8 )\end{matrix}$$

The detection unit 15c measures a change in output of this feature AS, and when the feature AS has changed, the detection unit 15c determines that data before addition of an adversarial noise is an adversarial example. In this manner, the detection unit 15c detects an adversarial example by using a change in output at the time of inputting data to the deep learning model.

[Detection Processing]

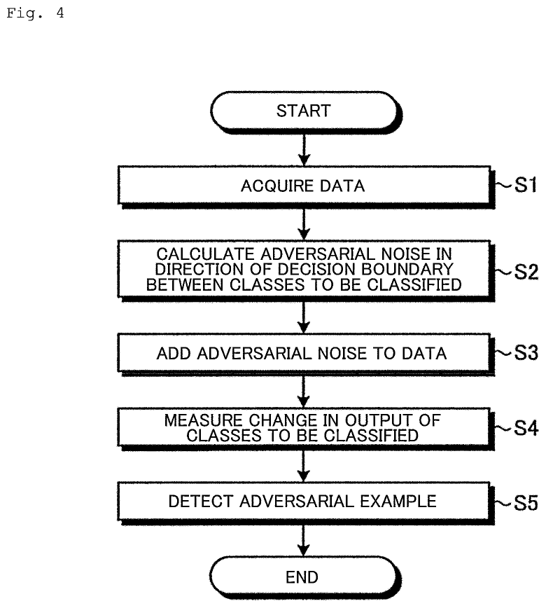

Next, description is given of detection processing to be executed by the detection device 10 according to this embodiment with reference to FIG. 4. FIG. 4 is a flow chart illustrating a detection processing procedure. The flow chart of FIG. 4 is started at a timing at which a user has input an operation of instructing start, for example.

First, the acquisition unit 15a acquires data to be classified by using a deep learning model (Step S1). Next, the conversion unit 15b calculates an adversarial noise in a direction that approaches a decision boundary between classes to be classified by the deep learning model (Step S2). Furthermore, the conversion unit 15b executes data conversion of adding the calculated adversarial noise to the data (Step S3).

The detection unit 15c measures a change in output between the data acquired and the data converted at a time when the data acquired and the data converted are input to the deep learning model (Step S4), and detects an adversarial example (Step S5). For example, when the output class has changed, the detection unit 15c determines that the data is an adversarial example. In this manner, a series of detection processing are finished.

As described above, in the detection device 10 according to this embodiment, the acquisition unit 15a acquires data to be classified by using a deep learning model. Furthermore, the conversion unit 15b converts the data acquired by using a noise in a predetermined direction. Specifically, the conversion unit 15b converts the data by using a noise in a direction that approaches a decision boundary between classes to be classified by the deep learning model. Furthermore, the detection unit 15c detects an adversarial example by using a change in output between the data acquired and the data converted at a time when the data acquired and the data converted are input to the deep learning model.

In this manner, the detection device 10 can detect the adversarial example (β1, β2) exemplified in FIG. 1(b), which cannot be detected by a random noise. Furthermore, it is possible to efficiently detect the adversarial example β exemplified in FIG. 1(a) through detection using a random noise.

Furthermore, the conversion unit 15b repeats the processing of calculating a noise and converting data by using the calculated noise a plurality of number of times. In this manner, the conversion unit 15b can execute data conversion of adding a noise in the direction of the decision boundary more accurately. Therefore, the detection device 10 can detect an adversarial example accurately.

Furthermore, the detection unit 15c calculates a predetermined feature of data, which changes in response to a change in output of the deep learning model, and uses a change of the feature between the data acquired and the data converted to detect an adversarial example. In this manner, it is possible to detect a change in output of the deep learning model accurately. Therefore, the detection device 10 can detect an adversarial example accurately.

### EXAMPLE

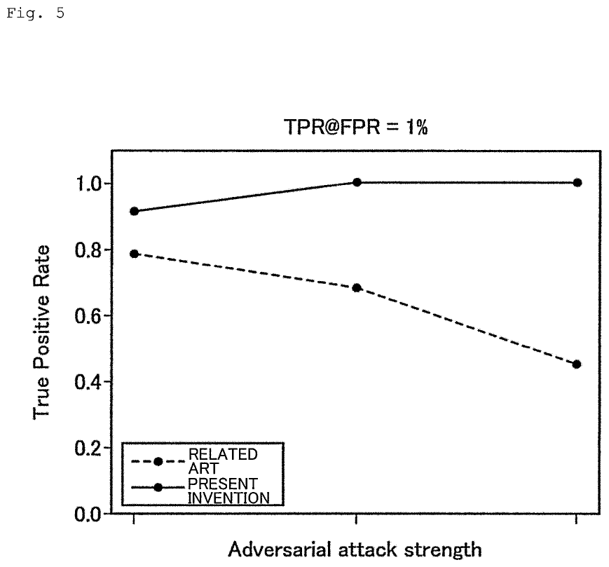

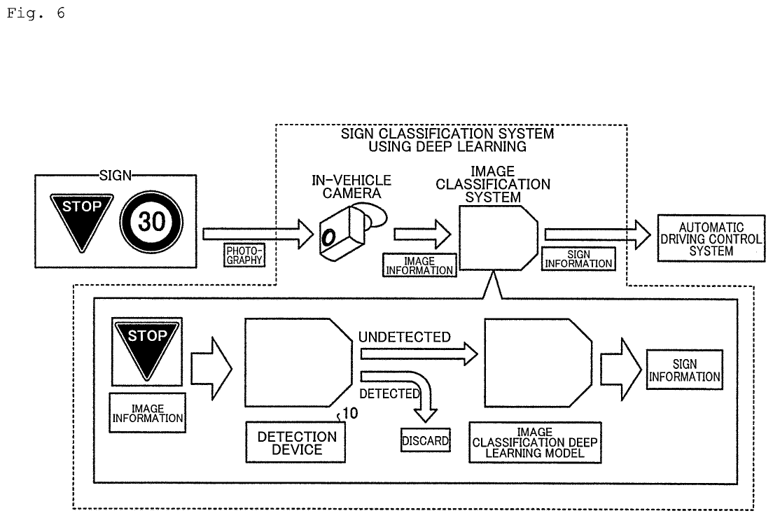

FIG. 5 and FIG. 6 are diagrams for describing an example. First, FIG. 5 describes an example of a result of evaluating performances of the present invention and the related art using a random noise. The vertical axis of the graph of FIG. 5 represents a detection rate of an adversarial example. The value of this detection rate is a value in a case where an erroneous detection rate of erroneously detecting that a clean sample is an adversarial example is suppressed to 1%. The horizontal axis of the graph represents the magnitude of an adversarial noise at a time when an adversarial example to be detected is created. As the noise becomes larger, the conversion distance at a time when the attacker creates an adversarial example from the clean sample becomes larger, and thus an adversarial example is likely to be created at a position that greatly exceeds the decision boundary. In other words, as the magnitude of the adversarial noise on the attack side becomes larger, an adversarial example that the related art has a difficulty in detecting is more likely to be created.

As illustrated in FIG. 5, it is understood that the detection processing of the detection device 10 according to the present invention has a higher detection rate than that of the processing of the related art. Furthermore, it is understood that the related art has a lower detection rate as the magnitude of the adversarial noise on the attack side becomes larger, whereas the detection rate does not become lower in the detection processing of the present invention. It is considered that this is because the present invention executes data conversion of adding a noise in the direction of the decision boundary accurately.

FIG. 6 describes an example of a case in which the detection device 10 according to the embodiment described above is applied to a sign classification system using deep learning. A self-driving vehicle photographs and recognizes a sign on a road by an in-vehicle camera, and uses the recognized sign for control of the vehicle body. In that case, image information on a sign taken in by the in-vehicle camera is classified into each sign by an image classification system using a deep learning model that has learned each sign in advance.

When the image information taken in by the in-vehicle camera is set to be an adversarial example, the vehicle body is controlled based on erroneous sign information, resulting in a danger of causing human damage.

In view of this, as illustrated in FIG. 6, through application of the detection device 10 to the image classification system, image information on a sign set to be an adversarial example is detected and discarded before the image information is input to a deep learning model that executes image classification. In this manner, the detection device 10 provides an effective countermeasure for an attack using an adversarial example targeting the image classification system using deep learning.

[Program]

It is also possible to create a program that describes the processing to be executed by the detection device 10 according to the embodiment described above in a language that can be executed by a computer. In one embodiment, the detection device 10 can be implemented by installing a detection program that executes the detection processing described above into a desired computer as package software or online software. For example, it is possible to cause an information processing device to function as the detection device 10 by causing the information processing device to execute the detection program described above. The information processing device herein includes a desktop computer or a laptop personal computer. In addition to these computers, the scope of the information processing device includes, for example, a mobile communication terminal such as a smartphone, a mobile phone, or a PHS (Personal Handyphone System), and a slate terminal such as a PDA (Personal Digital Assistant). The function of the detection device 10 may be implemented by a cloud server.

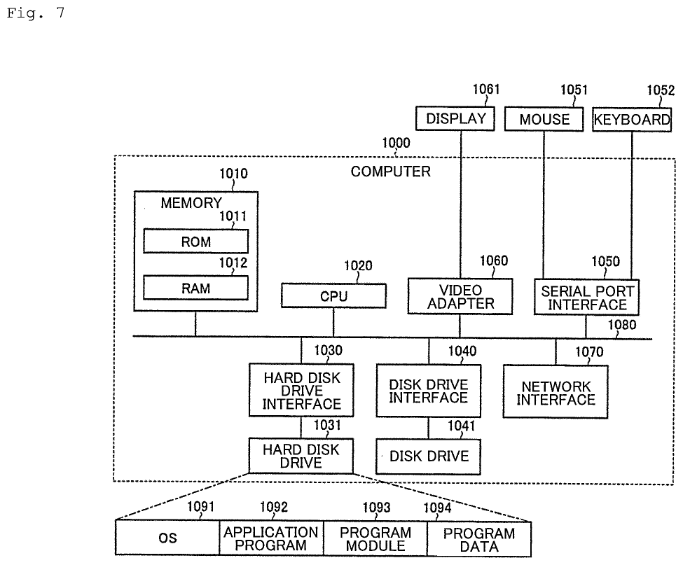

FIG. 7 is a diagram illustrating an example of a computer that executes a detection program. A computer 1000 includes, for example, a memory 1010, a CPU 1020, a hard disk drive interface 1030, a disk drive interface 1040, a serial port interface 1050, a video adapter 1060, and a network interface 1070. These units are connected to one another via a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1031. The disk drive interface 1040 is connected to a disk drive 1041. The disk drive 1041 is inserted into, for example, a removable storage medium such as a magnetic disk or an optical disc. For example, a mouse 1051 and a keyboard 1052 are connected to the serial port interface 1050. For example, a display 1061 is connected to the video adapter 1060.

The hard disk drive 1031 stores, for example, an OS 1091, an application program 1092, a program module 1093, and program data 1094. Each information described in the embodiment described above is stored in the hard disk drive 1031 or the memory 1010, for example.

The detection program is stored in the hard disk drive 1031 as the program module 1093 describing a command to be executed by the computer 1000, for example. Specifically, the program module 1093 describing each processing to be executed by the detection device 10 described in the embodiment described above is stored in the hard disk drive 1031.

Data to be used for information processing by the detection program is stored in, for example, the hard disk drive 1031 as the program data 1094. Then, the CPU 1020 reads the program module 1093 or the program data 1094 stored in the hard disk drive 1031 into the RAM 1012 as necessary, and executes each processing described above.

The program module 1093 or the program data 1094 relating to the detection program is not necessarily stored in the hard disk drive 1031, and for example, may be stored in a removable storage medium and read by the CPU 1020 via the disk drive 1041 or the like. Alternatively, the program module 1093 or the program data 1094 relating to the detection program may be stored in another computer connected via a network such as a LAN or a WAN (Wide Area Network), and may be read by the CPU 1020 via the network interface 1070.

In the above, the embodiment to which the invention made by the inventor is applied has been described. The present invention is not limited by the description and drawings of this embodiment forming a part of disclosure of the present invention. In other words, the scope of the present invention includes, for example, all of other embodiments, examples, and applied technologies made by a person skilled in the art or the like on the basis of this embodiment.

### REFERENCE SIGNS LIST

10 Detection device
11 Input unit
12 Output unit
13 Communication control unit
14 Storage unit
15 Control unit
15a Acquisition unit
15b Conversion unit
15c Detection unit

1. A detection device, comprising:
acquisition circuitry configured to acquire data to be classified using a model;
conversion circuitry configured to convert the data acquired using noise in a predetermined direction; and
detection circuitry configured to detect an adversarial example using a change in output between the data acquired and the data converted, at a time when the data acquired and the data converted are input to the model.

2. The detection device according to claim 1, wherein:
the conversion circuitry is configured to convert the data using noise in a direction that approaches a decision boundary between classes to be classified by the model as the noise in a predetermined direction.

3. The detection device according to claim 1, wherein the conversion circuitry is configured to repeat processing of calculating the noise and converting the data using the calculated noise a plurality of number of times.

4. The detection device according to claim 1, wherein:
the detection circuitry is configured to calculate a predetermined feature value of the data, which changes in response to a change in the output, and detect an adversarial example using a change in the predetermined feature value between the data acquired and the data converted.

5. A detection method to be executed by a detection device, comprising:
acquiring data to be classified using a model;
converting the data acquired using noise in a predetermined direction; and
detecting an adversarial example using a change in output between the data acquired and the data converted, at a time when the data acquired and the data converted are input to the model.

6. A non-transitory computer readable medium including a detection program which when executed causes:
acquiring data to be classified using a model;
converting the data acquired using noise in a predetermined direction; and
detecting an adversarial example using a change in output between the data acquired and the data converted, at a time when the data acquired and the data converted are input to the model.

7. The method according to claim 5, wherein:
the converting converts the data using noise in a direction that approaches a decision boundary between classes to be classified by the model as the noise in a predetermined direction.

8. The method according to claim 5, further comprising:
repeating processing of calculating the noise and converting the data using the calculated noise a plurality of number of times.

9. The method according to claim 5, wherein:
the detecting calculates a predetermined feature value of the data, which changes in response to a change in the output, and detects an adversarial example using a change in the predetermined feature value between the data acquired and the data converted.

10. The non-transitory computer readable medium according to claim 6, wherein the program further causes:
the converting to convert the data using noise in a direction that approaches a decision boundary between classes to be classified by the model as the noise in a predetermined direction.

11. The non-transitory computer readable medium according to claim 6, wherein the program further causes:
repeating processing of calculating the noise and converting the data using the calculated noise a plurality of number of times.

12. The non-transitory computer readable medium according to claim 6, wherein the program further causes:
the detecting to calculate a predetermined feature value of the data, which changes in response to a change in the output, and to detect an adversarial example using a change in the predetermined feature value between the data acquired and the data converted.
